(19) United States
(12) Patent Application Publication
(10) Pub. No.: US 2026/0051515 A1
(43) Pub. Date: Feb. 19, 2026

(54) METHOD FOR MANUFACTURING OF ANODE FOR FUEL CELL AND LAYERED STRUCTURE FOR ANODE

(71) Applicant: MICO POWER LTD., Anseong-si (KR)

(72) Inventors: Seok-Gyun YOO, Anseong-si (KR); Jin-Ah PARK, Anseong-si (KR); Song-Ho CHOI, Anseong-si (KR); Dae-Han LEE, Anseong-si (KR)

(21) Appl. No.: 19/296,924

(22) Filed: Aug. 11, 2025

(30) Foreign Application Priority Data
Aug. 14, 2024 (KR) 10-2024-0108852

(51) Int. Cl. H01M 4/88

(52) U.S. Cl. CPC H01M 4/8875; H01M 4/8885; H01M 4/8896

(57) ABSTRACT

A method of manufacturing an anode for a fuel cell is provided. The method includes preparing a plurality of first green sheets elongated in one direction by shaping a first slurry containing YSZ, nickel, and a pore forming agent, preparing a second green sheet elongated in one direction by shaping a second slurry containing YSZ and nickel, preparing a first intermediate laminate by laminating the plurality of first green sheets alternately such that elongation directions of the first green sheets intersect, and then laminating the second green sheet thereon such that an elongation direction of the second green sheet intersects with that of an uppermost first green sheet, and pressure-sintering the first intermediate laminate.

This application claims the benefit of Korean Patent Application No. 10-2024-0108852 filed on Aug. 14, 2024, in the Korean Intellectual Property Office, the entire disclosure of which is incorporated herein by reference for all purposes.

### BACKGROUND

### 1. Field of the Invention

The present disclosure relates to a method of manufacturing an anode for a fuel cell and a laminated structure for a fuel cell anode manufactured using the same.

### 2. Description of the Related Art

A solid oxide fuel cell (SOFC) is a device that converts chemical energy of fuel into electrical energy through an electrical reaction. SOFCs may be divided into electrolyte-supported and electrode-supported types depending on the structural support layer. A fuel electrode-supported solid oxide generally includes a cathode, an electrolyte, an anode functional layer, and an anode support layer.

In order to secure a high level of mechanical strength, the anode support layer may be formed by laminating multiple anode support green sheets, but there are limitations to this approach. In addition, the anode support green sheet develops anisotropy according to the forming direction during casting, and there is a problem that the degree of shrinkage varies during sintering depending on the longitudinal and transverse directions relative to the forming direction. Accordingly, there is a need for an improved method capable of overcoming such problems and obtaining a sintered body of uniform size.

### PRIOR-ART DOCUMENT

### Patent Document

(Patent Document 1) Korean Patent Application Publication No. 10-2017-0010625

### SUMMARY

### Problem to be Solved by the Invention

An object of the present disclosure is to provide a method of manufacturing an anode for a fuel cell in which a plurality of green sheets are alternately stacked to control sintering behavior, thereby enabling manufacturing of uniform single cells.

Another object of the present disclosure is to provide a laminated structure for a fuel cell anode in which the high level of strength is secured.

### Means for Solving the Problem

In order to achieve the above objects, the present disclosure provides a method of manufacturing an anode for a fuel cell including: preparing a plurality of first green sheets elongated in one direction by shaping a first slurry containing YSZ, nickel, and a pore forming agent mixed in a first weight ratio; preparing a second green sheet elongated in one direction by shaping a second slurry containing YSZ and nickel mixed in a second weight ratio; preparing a first intermediate laminate by laminating the plurality of first green sheets alternately such that elongation directions of the first green sheets intersect and then laminating the second green sheet thereon such that an elongation direction of the second green sheet intersects with that of an uppermost first green sheet; and pressure-sintering the first intermediate laminate.

In addition, the present disclosure provides a method of manufacturing an anode for a fuel cell including: preparing a plurality of first green sheets elongated in one direction by shaping a first slurry containing YSZ, nickel, and a pore forming agent mixed in a first weight ratio; laminating the plurality of first green sheets alternately such that elongation directions of the first green sheets intersect; preparing a second intermediate laminate by applying a second slurry containing YSZ and nickel mixed in a second weight ratio on the laminated first green sheets; and pressure-sintering the second intermediate laminate.

In addition, the present disclosure provides a laminated structure for a fuel cell anode including: a laminate for a fuel electrode support, in which a plurality of first green sheets prepared to be elongated in one direction using a first slurry containing YSZ, nickel, and a pore forming agent mixed in a first weight ratio are laminated alternately such that elongation directions of the first green sheets intersect; and a second green sheet which is prepared to be elongated in one direction using a second slurry containing YSZ and nickel mixed in a second weight ratio, and is laminated on an uppermost first green sheet of the laminate for a fuel electrode support such that an elongation direction of the second green sheet intersects with that of the uppermost first green sheet.

### Effects of the Invention

According to the present disclosure, in a method of manufacturing an anode for a fuel cell of the present disclosure, green sheets are laminated while crossing each other, such that uniform shrinkage occurs during sintering, thereby enabling the size of the single cell to be made uniform.

In addition, a laminated structure for a fuel cell anode of the present disclosure may have excellent strength.

### BRIEF DESCRIPTION OF THE DRAWINGS

FIG. 1 is a flowchart illustrating a method of manufacturing an anode for a fuel cell according to an embodiment of the present disclosure.

FIG. 2 shows diagrams illustrating lamination of green sheets.

FIG. 3 is a flowchart illustrating a method of manufacturing an anode for a fuel cell according to another embodiment of the present disclosure.

FIG. 4 shows images obtained by observing a microstructure of Example 2.

FIGS. 5A-5B show results of three-point bending strength measurements of Example 2 and Comparative Example 2.

### DETAILED DESCRIPTION

Hereinafter, embodiments of the present disclosure will be described in detail with reference to the attached drawings. The present disclosure may be modified in various ways and may take various forms, and thus specific embodiments are illustrated in the drawings and described in detail in the text. However, this is not intended to limit the present disclosure to a specific disclosed form, but should be understood to include all modifications, equivalents, and substitutes included in the spirit and technical scope of the present disclosure. Similar reference numerals have been used for similar components in describing each drawing. In the attached drawings, the dimensions of structures are illustrated to be larger than actual dimensions for the clarity of the present disclosure.

The terms such as first and second may be used to describe various components, but the components should not be limited by the terms. The terms are used only for the purpose of distinguishing one component from another. For example, without departing from the scope of the present disclosure, the first component may be referred to as the second component, and similarly, the second component may also be referred to as the first component.

The terms used in the present application are used only to describe specific embodiments and are not intended to limit the present disclosure. Singular expressions include plural expressions unless the context clearly indicates otherwise. In the present application, it should be understood that terms such as “include” or “have” are intended to specify the presence of a feature, number, step, operation, component, part or a combination thereof described in the specification, but do not exclude in advance the possibility of the presence or addition of one or more other features, numbers, steps, operations, components, parts or combinations thereof.

Unless otherwise defined, all terms used herein, including technical or scientific terms, have the same meaning as generally understood by a person of ordinary skill in the art to which the present disclosure belongs. Terms such as those defined in commonly used dictionaries should be interpreted as having a meaning consistent with the meaning they have in the context of the relevant technology, and shall not be interpreted in an ideal or excessively formal meaning unless explicitly defined in the present application.

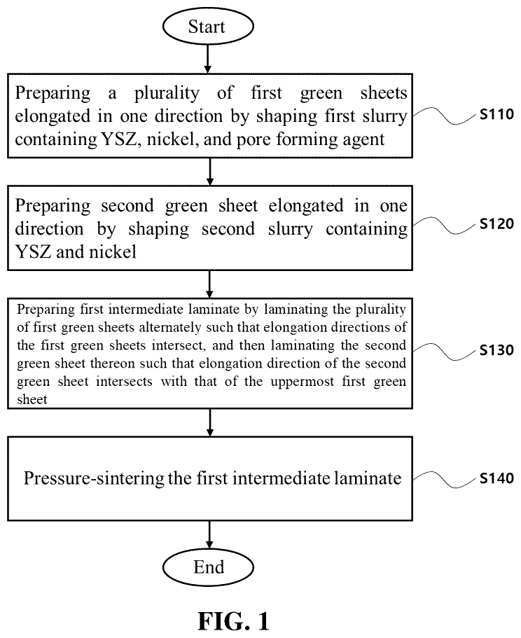

FIG. 1 is a flowchart illustrating a method of manufacturing an anode for a fuel cell according to an embodiment of the present disclosure.

Referring to FIG. 1, a method of manufacturing an anode for a fuel cell according to an embodiment of the present disclosure may include preparing a plurality of first green sheets elongated in one direction by shaping a first slurry containing YSZ, nickel, and a pore forming agent (S110); preparing a second green sheet elongated in one direction by shaping a second slurry containing YSZ and nickel (S120); preparing a first intermediate laminate by laminating the plurality of first green sheets alternately such that elongation directions of the first green sheets intersect and then laminating the second green sheet thereon such that an elongation direction of the second green sheet intersects with that of an uppermost first green sheet (S130); and pressure-sintering the first intermediate laminate (S140).

In the step of preparing the first green sheets (S110), the first slurry may include NiO and YSZ in a weight ratio of (1.5 to 2):1. The first green sheet is for preparing an anode support, and in order to improve the electrical conductivity of the anode support, the first slurry may have a relatively high Ni content.

In an embodiment, the first slurry may contain about 15 to 25 volume % (vol %) of the pore forming agent. For example, the first slurry may contain about 20 vol % of the pore forming agent, and the pore forming agent may include any one selected from the group consisting of polymethyl methacrylate (PMMA), activated carbon, carbon black, graphite, and starch. Since the first green sheet includes the pore forming agent, pores through which a fluid, for example, a fuel gas, can move may be formed inside the anode support for a fuel cell.

In an embodiment, the first slurry may be prepared by mixing NiO, YSZ, and the pore forming agent, dispersing them in a solvent, and adding a binder thereto. The binder may be a polyvinyl alcohol (PVA) binder, a methylcellulose (MC) binder, a sodium carboxymethylcellulose (CMC) binder, or the like, which may be used alone or in a mixture of two or more.

In an embodiment, the first green sheet may be prepared through a process such as extrusion molding or tape casting using the first slurry, but is not limited thereto.

In an embodiment, the thickness of one first green sheet may be 220 to 240 μm.

In the step of preparing the second green sheet (S120), the second slurry may include NiO and YSZ in a weight ratio of (1 to 1.5):1. The second green sheet is for preparing an anode functional layer disposed adjacent to a solid oxide electrolyte, and the second slurry may not include a pore forming agent so that the anode functional layer may form a further increased triple point (gas/electrolyte/electrode), and may include a lower content of Ni than the first slurry so that the anode functional layer has lower electrical conductivity than the anode support layer.

In an embodiment, the second slurry may be prepared by mixing NiO and YSZ, dispersing them in a solvent, and adding a binder thereto. Since the binder is the same as described above, redundant description is omitted.

In an embodiment, the thickness of the second green sheet may be 10 to 14 μm.

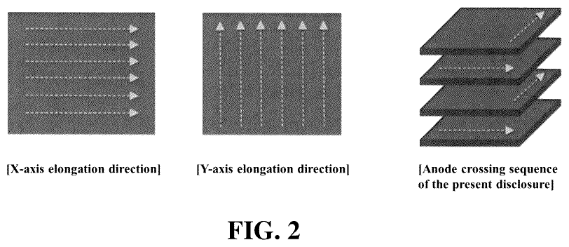

The step of preparing the first intermediate laminate (S130) may include laminating two or more first green sheets alternately such that their elongation directions intersect, and then laminating the second green sheet thereon such that their elongation directions intersect, as shown in FIG. 2.

In the step of pressure-sintering (S140), the sintering may be performed in an atmospheric environment at about 1,300° C. to 1,500° C. During the pressure-sintering of the first intermediate laminate, pores corresponding to the pore forming agent may be formed inside the first green sheet, and the first and second green sheets may be integrally combined, and as a result, the first intermediate laminate may be converted into an anode for a fuel cell formed of Ni-YSZ cermet.

In an embodiment, in the case that the first and second green sheets are laminated such that their elongation directions intersect, uniform X-axis and Y-axis shrinkage of the first and second green sheets may be induced during the pressure-sintering, and as a result, an anode for a fuel cell having improved strength may be manufactured.

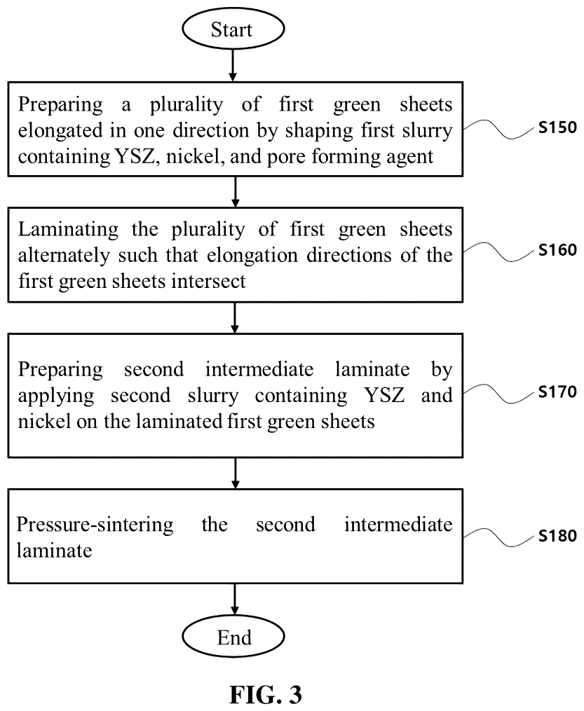

FIG. 3 is a flowchart illustrating a method of manufacturing an anode for a fuel cell according to another embodiment of the present disclosure.

Referring to FIG. 3, a method of manufacturing an anode for a fuel cell according to another embodiment of the present disclosure may include preparing a plurality of first green sheets elongated in one direction by shaping a first slurry containing YSZ, nickel, and a pore forming agent (S150); laminating the plurality of first green sheets alternately such that elongation directions of the first green sheets intersect (S160); preparing a second intermediate laminate by applying a second slurry containing YSZ and nickel on the laminated first green sheets (S170); and pressure-sintering the second intermediate laminate (S180).

The step of preparing the first green sheets (S150) is substantially the same as the step of preparing the first green sheets (S110) of the method of manufacturing an anode for a fuel cell described with reference to FIG. 1, and therefore, a detailed description thereof will be omitted.

The step of preparing the second intermediate laminate (S170) may include applying a second slurry onto the first green sheets alternately laminated such that the elongation directions intersect, to form a second slurry layer corresponding to the anode functional layer. The method of forming the second slurry layer on the first green sheet is not particularly limited. For example, the second slurry layer may be formed by applying the second slurry onto the first green sheet by a method such as bar coating.

In the step of pressure-sintering (S180), the sintering may be performed in an atmospheric environment at about 1,300° C. to 1,500° C. During the pressure-sintering of the second intermediate laminate, pores corresponding to the pore forming agent may be formed inside the first green sheet, and the first and second green sheets may be integrally combined, and as a result, the second intermediate laminate may be converted into an anode for a fuel cell formed of Ni-YSZ cermet.

In an embodiment, the deviation of the longitudinal length and the transverse length in the elongation direction after sintering of the first or second intermediate laminate may be 0.75% or less of the length of the first or second green sheet. If the deviation of the length exceeds about 0.75%, anisotropy may be formed in the laminate for the fuel electrode support, which may be disadvantageous for fuel cell application.

The laminated structure for a fuel cell anode according to an embodiment of the present disclosure may include the first intermediate laminate or the second intermediate laminate described above.

In an embodiment, the laminated structure for a fuel cell anode may include a laminate for a fuel electrode support, in which a plurality of first green sheets prepared to be elongated in one direction using a first slurry containing YSZ, nickel, and a pore forming agent are laminated alternately such that elongation directions of the first green sheets intersect; and a second green sheet which is prepared to be elongated in one direction using a second slurry containing YSZ and nickel, and is laminated on an uppermost first green sheet of the laminate for a fuel electrode support such that an elongation direction of the second green sheet intersects with that of the uppermost first green sheet.

In an embodiment, the pore forming agent, the first and second slurries, and the first and second green sheets are substantially the same as the pore forming agent, the first and second slurries, and the first and second green sheets described in the manufacturing method described with reference to FIG. 1, respectively, and therefore, redundant detailed descriptions thereof are omitted.

Hereinafter, in order to help understand the present disclosure, examples will be given in detail. However, the following examples are only to illustrate the content of the present disclosure and the scope of the present disclosure is not limited to the following examples. The examples of the present disclosure are provided to more completely describe the present disclosure to a person having average knowledge in the art.

### Examples 1 to 5

A first slurry was prepared by mixing NiO and YSZ in a solvent at a weight ratio of (1.5 to 2):1, and then adding and mixing about 20 vol % of a pore forming agent. The first slurry was tape casted to prepare an anode support layer green sheet. The anode support layer green sheets were prepared according to the number shown in Table 1 below. A second slurry was prepared by mixing NiO and YSZ in a solvent at a weight ratio of (1 to 1.5):1. The second slurry was tape casted to prepare an anode functional layer green sheet. A plurality of anode support layer green sheets were laminated such that their elongation directions intersected with each other. The anode functional layer green sheet was laminated such that the elongation direction is intersected with that of the uppermost surface of the laminated anode support layer green sheets. The laminated structure was pressure-sintered in an atmospheric environment at about 1,300° C. to 1,500° C. to prepare a fuel electrode. The sintered layer consisted of four layers of anode support layers and one layer of anode functional layer.

TABLE 1

| | Total sintered layer |
|---|---|
| Example 1 | 3 |
| Example 2 | 5 |
| Example 3 | 7 |
| Example 4 | 9 |
| Example 5 | 11 |

### Comparative Examples 1 to 5

Except that the green sheets were laminated such that the elongation directions of the green sheets matched in Example 1, fuel electrodes were prepared in the same manner as in Example 1.

### Experimental Example 1

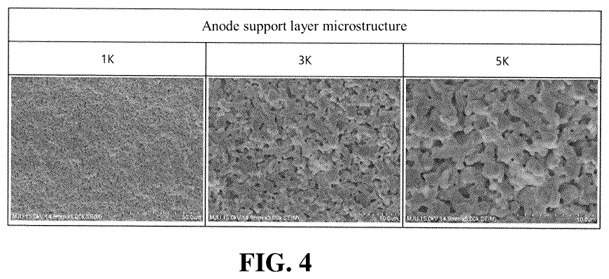

FIG. 4 is an image observing a microstructure of Example 2. The surface of the anode support layer of Example 2 was observed at various magnifications using a scanning electron microscope (SEM). It was confirmed that the porosity of the anode support layer green sheets was maintained even after sintering.

Table 2 shows the results comparing the shrinkage rates of Examples 1 to 5 and Comparative Examples 1 to 5. The longitudinal and transverse directions with respect to the elongation direction of the green sheets are indicated by the X-axis and the Y-axis. It was confirmed that Examples 1 to 5 had an X-Y deviation of within 0.15 mm, and that the X-Y deviation ratio relative to the size of the green sheets was within 0.75%. Comparative Examples 1 to 5 showed an X-Y deviation of up to 0.6 mm. Through this, it was confirmed that the green sheets were cross-laminated and uniformly shrunk during sintering manufacturing.

TABLE 2

| | | Average size | | | | | | Average size | | | |
|---|---|---|---|---|---|---|---|---|---|---|---|
| | | | | Shrinkage | | | | | | Shrinkage | |
| Order of | Sintered | X | Y | rate | X − Y | Order of | Sintered | X | Y | rate | X − Y |
| laminating | layer | (mm) | (mm) | (%) | (mm) | laminating | layer | (mm) | (mm) | (%) | (mm) |
| → | 11 | 131.42 | 130.84 | 35.55 | 0.58 | → | 11 | 131.22 | 131.31 | 34.76 | −0.09 |
| → | | 131.2 | 130.85 | 35.64 | 0.35 | ↑ | | 131.07 | 131.03 | 34.64 | 0.04 |
| → | 9 | 131.44 | 131.22 | 35.19 | 0.22 | → | 9 | 130.65 | 130.5 | 34.82 | 0.15 |
| → | | 130.71 | 130.33 | 34.80 | 0.38 | ↑ | | 130.69 | 130.54 | 34.78 | 0.15 |
| | 7 | 131.25 | 130.65 | 34.27 | 0.6 | | 7 | 130.79 | 130.71 | 34.59 | 0.08 |
| | | 131.04 | 130.56 | 34.48 | 0.48 | | | 130.78 | 130.74 | 34.72 | 0.04 |
| | 5 | 130.73 | 130.6 | 34.40 | 0.13 | | 5 | 130.55 | 130.52 | 34.76 | 0.03 |
| | | 131.19 | 130.9 | 34.62 | 0.29 | | | 130.62 | 130.65 | 34.92 | −0.03 |
| | 3 | 131.16 | 130.92 | 34.60 | 0.24 | | 3 | 131.36 | 131.42 | 34.07 | −0.06 |
| | | 131.46 | 131.06 | 34.58 | 0.4 | | | 131.68 | 131.77 | 33.98 | −0.09 |

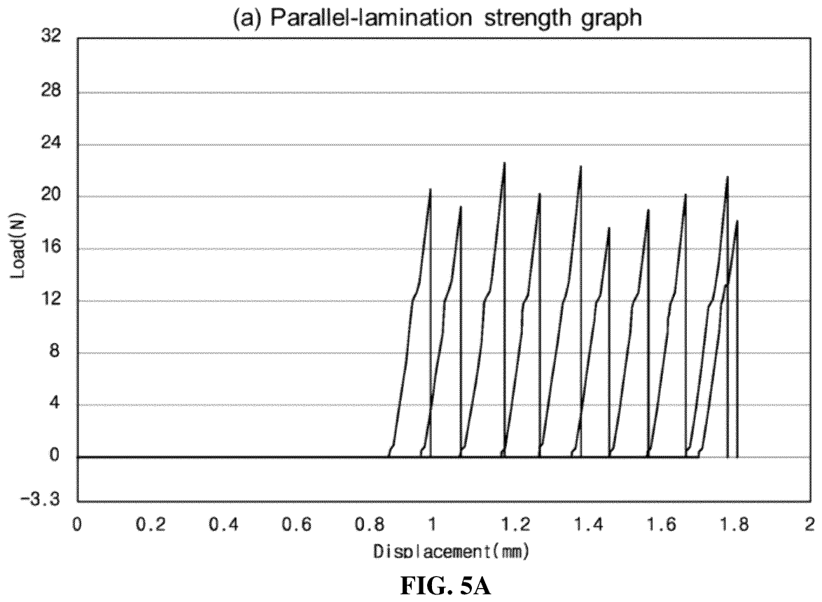

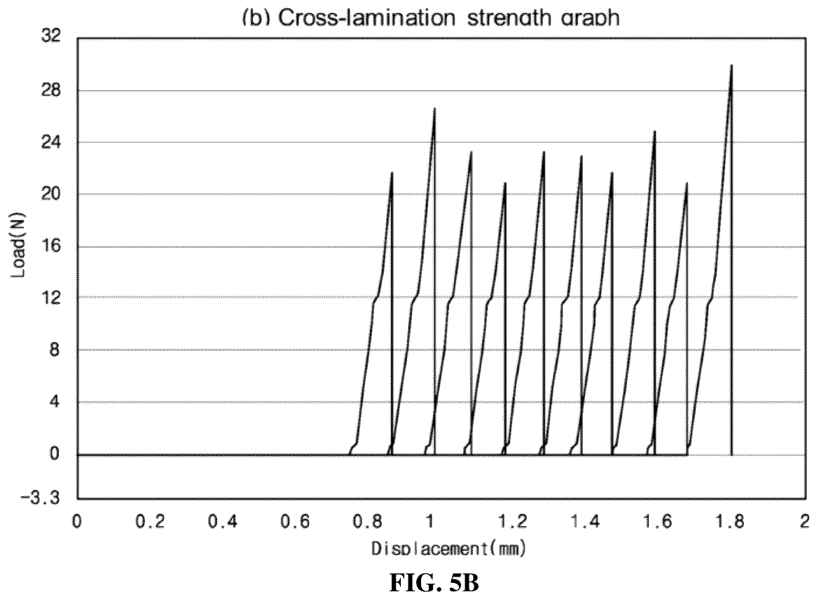

FIGS. 5A-5B and Table 3 show the results of three-point bending strength measurements of Example 2 and Comparative Example 2. Ten specimens were prepared and measured 10 times with a universal testing machine. The average tensile strength of Example 2 was recorded as about 137.5 MPa, and that of Comparative Example 2 was recorded as about 115.4 MPa.

TABLE 3

| Parallel lamination | | | Cross lamination | | |
|---|---|---|---|---|---|
| | N | MPa | | N | MPa |
| 1 | 18.38 | 104.35 | 1 | 21.95 | 123.13 |
| 2 | 20.61 | 117.34 | 2 | 26.45 | 151.07 |
| 3 | 19.18 | 110.50 | 3 | 27.95 | 157.73 |
| 4 | 22.58 | 128.60 | 4 | 20.88 | 119.96 |
| 5 | 20.04 | 114.47 | 5 | 23.85 | 135.80 |
| 6 | 22.44 | 127.79 | 6 | 23.04 | 132.76 |
| 7 | 17.74 | 101.62 | 7 | 21.74 | 123.04 |
| 8 | 19.05 | 110.08 | 8 | 25.02 | 143.33 |
| 9 | 20.09 | 115.05 | 9 | 20.73 | 117.72 |
| 10 | 21.54 | 124.48 | 10 | 30.11 | 170.42 |
| ave. | 20.16 | 115.43 | ave. | 24.17 | 137.49 |
| max | 22.58 | 128.60 | max | 30.11 | 170.42 |
| min | 17.74 | 101.62 | min | 20.73 | 117.72 |

Although the above has been described with reference to preferred embodiments of the present disclosure, those skilled in the art will understand that the present disclosure may be variously modified and changed without departing from the spirit and scope of the present disclosure as set forth in the appended claims.

What is claimed is:

1. A method of manufacturing an anode for a fuel cell, the method comprising:
preparing a plurality of first green sheets elongated in one direction by shaping a first slurry comprising YSZ, nickel, and a pore forming agent;
preparing a second green sheet elongated in one direction by shaping a second slurry comprising YSZ and nickel;
preparing a first intermediate laminate by laminating the plurality of first green sheets alternately such that elongation directions of the first green sheets intersect and then laminating the second green sheet thereon such that an elongation direction of the second green sheet intersects with that of an uppermost first green sheet; and
pressure-sintering the first intermediate laminate.

2. A method of manufacturing an anode for a fuel cell, the method comprising:
preparing a plurality of first green sheets elongated in one direction by shaping a first slurry comprising YSZ, nickel, and a pore forming agent;
laminating the plurality of first green sheets alternately such that elongation directions of the first green sheets intersect;
preparing a second intermediate laminate by applying a second slurry comprising YSZ and nickel on the laminated first green sheets; and
pressure-sintering the second intermediate laminate.

3. The method according to claim 1, wherein the first slurry comprises NiO and YSZ in a weight ratio of (1.5 to 2):1, and
the second slurry comprises NiO and YSZ in a weight ratio of (1 to 1.5):1.

4. The method according to claim 3, wherein the first slurry comprises 15 to 25 vol % of the pore forming agent.

5. The method according to claim 4, wherein the pore forming agent comprises any one selected from a group consisting of polymethyl methacrylate (PMMA), activated carbon, carbon black, graphite, and starch.

6. The method according to claim 1, wherein a thickness of one of the first green sheets is 220 to 240 μm, and
a thickness of the second green sheet is 10 to 14 μm.

7. The method according to claim 1, wherein the sintering is performed by pressure-sintering in an atmospheric environment at 1,300° C. to 1,500° C.

8. The method according to claim 1, wherein a deviation of a longitudinal length and a transverse length in the elongation direction after sintering of the first or second intermediate laminate is 0.75% or less of a length of the first or second green sheet.

9. A laminated structure for a fuel cell anode, the laminated structure comprising:
a laminate for a fuel electrode support, in which a plurality of first green sheets prepared to be elongated in one direction using a first slurry comprising YSZ, nickel, and a pore forming agent are laminated alternately such that elongation directions of the first green sheets intersect; and
a second green sheet which is prepared to be elongated in one direction using a second slurry comprising YSZ and nickel, and is laminated on an uppermost first green sheet of the laminate for a fuel electrode support such that an elongation direction of the second green sheet intersects with that of the uppermost first green sheet.

10. The laminated structure according to claim 9, wherein the first slurry comprises NiO and YSZ in a weight ratio of (1.5 to 2):1, and
the second slurry comprises NiO and YSZ in a weight ratio of (1 to 1.5):1.

11. The laminated structure according to claim 10, wherein the first slurry comprises 15 to 25 vol % of the pore forming agent.

12. The method according to claim 2, wherein the first slurry comprises NiO and YSZ in a weight ratio of (1.5 to 2):1, and
the second slurry comprises NiO and YSZ in a weight ratio of (1 to 1.5):1.

13. The method according to claim 2, wherein the sintering is performed by pressure-sintering in an atmospheric environment at 1,300° C. to 1,500° C.

14. The method according to claim 2, wherein a deviation of a longitudinal length and a transverse length in the elongation direction after sintering of the first or second intermediate laminate is 0.75% or less of a length of the first or second green sheet.
